(19) United States
(12) Patent Application Publication
(10) Pub. No.: US 2026/0244206 A1
(43) Pub. Date: Aug. 20, 2026

(54) ATTITUDE CONTROL APPARATUS, FLYING OBJECT, AND ATTITUDE CONTROL METHOD

(71) Applicant: CANON KABUSHIKI KAISHA, Tokyo (JP)

(72) Inventor: HIROTAKA SHINDO, Tokyo (JP)

(21) Appl. No.: 18/990,466

(22) Filed: Dec. 20, 2024

Related U.S. Application Data
(63) Continuation of application No. PCT/JP2023/018962, filed on May 22, 2023.

(30) Foreign Application Priority Data
Jul. 14, 2022 (JP) 2022-112828

(51) Int. Cl. G05D 1/49; G05D 1/689; G05D 109/25; G05D 111/10

(52) U.S. Cl. CPC G05D 1/498; G05D 1/689; G05D 2109/254; G05D 2111/10

(57) ABSTRACT

An attitude control apparatus included in a flying object configured to generate thrust in accordance with a control amount. The attitude control apparatus includes a movable unit that is movable relative to a body of the flying object, a drive unit configured to move the movable unit and a processor configured to output the control amount for restoring an attitude of the body when the attitude has changed and to control the drive unit to move the movable unit in a direction to restore the attitude.

### CROSS-REFERENCE TO RELATED APPLICATIONS

This application is a Continuation of International Patent Application No. PCT/JP2023/018962, filed on May 22, 2023, which claims the benefit of Japanese Patent Application No. 2022-112828, filed on July 14, 2022, which is hereby incorporated by reference herein in their entirety.

### BACKGROUND

### Technical Field

The present disclosure relates to attitude control of a flying object such as a drone.

### Description of Related Art

A flying object as described above is used for various applications such as transport and inspection and required to improve in terms of flight speed and weather resistance. To improve flight speed and weather resistance, attitude control needs to be performed to prevent abrupt attitude change of the flying object due to disturbances. However, for example, a conventional flying object that flies by rotating a plurality of propellers performs attitude control by controlling rotation of each propeller and thus cannot sufficiently prevent abrupt attitude change.

Japanese Patent No. 6752809 discloses a method of adjusting the overall center of gravity of a body by moving a weight when the payload or balance changes, such as during package transport. Japanese Patent No. 6508331 discloses a method of enabling efficient flight by tilting wings provided on a propeller-driven flying object.

However, the method disclosed in Japanese Patent No. 6752809 is not a method of restoring the attitude of a flying object by using a weight when the attitude has abruptly changed due to disturbances. The method disclosed in Japanese Patent No. 6508331 requires a mechanism for tilting a plurality of wings, which lead to a complicated structure.

### SUMMARY

One of the aspects of the present disclosure provides an attitude control apparatus capable of stabilizing a flying object.

An attitude control apparatus according to one aspect of the present disclosure is included in a flying object configured to generate thrust in accordance with a control amount. The attitude control apparatus includes a movable unit that is movable relative to a body of the flying object; a drive unit configured to move the movable unit; and a processor configured to output the control amount for restoring an attitude of the body when the attitude has changed and to control the drive unit to move the movable unit in a direction to restore the attitude.

Further features of the disclosure will become apparent from the following description of embodiments with reference to the attached drawings.

### BRIEF DESCRIPTION OF THE DRAWINGS

FIG. 1 is a block diagram illustrating an electric configuration of a flying object of Example 1.

FIG. 2 is a flowchart illustrating control processing in Example 1.

FIGS. 3A, 3B, and 3C are exterior diagrams illustrating the flying object of Example 1.

FIG. 4 is a block diagram illustrating an electric configuration of a flying object of Example 2.

FIG. 5 is a flowchart illustrating control processing in Example 2.

FIG. 6 is a block diagram illustrating an electric configuration of a flying object of Example 3.

FIG. 7 is a flowchart illustrating control processing in Example 3.

### DETAILED DESCRIPTION

In the following, the term "unit" may refer to a software context, a hardware context, or a combination of software and hardware contexts. In the software context, the term "unit" refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term "unit" refers to a hardware element, a circuit, an assembly, a physical structure, a system, a module, or a subsystem. Depending on the specific embodiment, the term "unit" may include mechanical, optical, or electrical components, or any combination of them. The term "unit" may include active (e.g., transistors) or passive (e.g., capacitor) components. The term "unit" may include semiconductor devices having a substrate and other layers of materials having various concentrations of conductivity. It may include a CPU or a programmable processor that can execute a program stored in a memory to perform specified functions. The term "unit" may include logic elements (e.g., AND, OR) implemented by transistor circuits or any other switching circuits. In the combination of software and hardware contexts, the term "unit" or "circuit" refers to any combination of the software and hardware contexts as described above. In addition, the term "element,"" assembly,"" component," or "device" may also refer to "circuit" with or without integration with packaging materials.

Examples of the present disclosure will be described below with reference to the accompanying drawings.

### Example 1

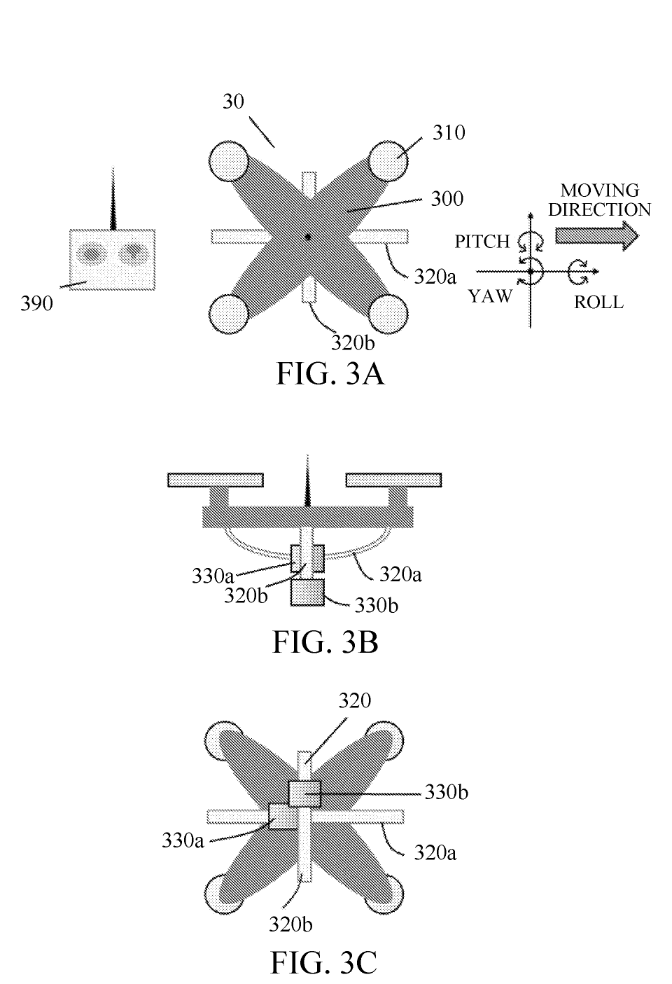

FIGS. 3A, 3B, and 3C illustrate the appearance of a drone 30 as a flying object of Example 1 when viewed from above, side, and below, respectively. The drone 30 includes a body 300 having an X shape when viewed from above and below, and four (a plurality of) propellers 310 provided at the distal ends of four arms of the body 300 (mutually different positions on the body). The propellers 310 rotate to generate upward, downward, forward, backward, rightward, and leftward thrust (propulsive force) necessary for flying the drone 30. The shape and number of blades of each propeller 310 are not particularly limited but may be those of a well-known configuration. Thus, detailed description thereof will be omitted.

The drone 30 is remotely operated through an instruction unit 390 as a transmitter operated by a pilot. The instruction unit 390 may be a dedicated controller or a portable terminal such as a smartphone with an operation app. The pilot may be a person or a computer provided for automatic control of the drone 30.

As illustrated in FIG. 3B, the body 300 is provided with two rails 320a and 320b extending in two directions, respectively, orthogonal to each other when viewed from above and below. The rails 320a and 320b hold weights 330a and 330b as movable units, respectively, movably in the longitudinal directions of the rails. The rails 320a and 320b each extend in a direction between two adjacent arms among the four arms of the body 300. In other words, when viewed from above and below, the directions (longitudinal directions) in which the two rails 320a and 320b extend are parallel to none of the directions in which the four arms extend. The weights 330a and 330b are moved along the rails 320a and 320b to stabilize the attitude of the body 300 to which attitude change has occurred.

Each rail may have a curved shape in which its central part is positioned below end parts in a direction of gravity (in other words, a curved shape that is convex in the gravity direction). This is because a reaction force applied to the body 300 when each weight moves along the corresponding rail acts in a direction (typically the horizontal direction) to stabilize the body 300. Moreover, the rails and the weights may be positioned lower than (on a gravity direction side further than) the center of gravity of the body 300. This is because the reaction force applied to the body 300 when each weight moves is likely to cause unnecessary attitude change to the body 300 if the weight is positioned upper than the center of gravity of the body 300.

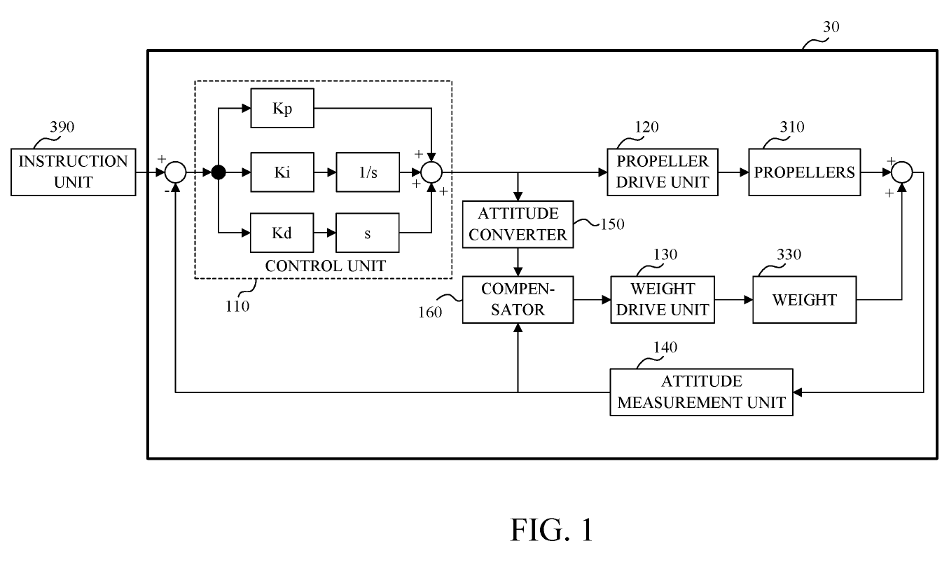

FIG. 1 illustrates an electric configuration for controlling flight of the drone 30. The drone 30 includes, inside the body 300, a control unit (first control unit) 110, a propeller drive unit 120, a weight drive unit (drive unit) 130, an attitude measurement unit (attitude detection unit) 140, an attitude converter (attitude estimation unit) 150, and a compensator (second control unit) 160.

The control unit 110 is a PID control unit configured to calculate a control amount necessary for controlling flight of the drone 30 in accordance with an instruction input from the instruction unit 390. The control amount is a value that controls ascent, descent, forward and backward movement of the drone 30 as well as their acceleration and deceleration.

The propeller drive unit 120 rotationally drives the propellers 310 at a rotation speed in accordance with the control amount input from the control unit 110.

The weight drive unit 130 moves the weights 330a and 330b (hereinafter collectively referred to as weight 330) based on a compensation amount input from the compensator 160. This assists swift restoration of the original attitude when the attitude of the body 300 is controlled through rotation control of the propellers 310 has changed. The weight drive unit 130 may be configured as, for example, a voice coil motor with a coil provided on one of a weight and a rail and a magnet provided on the other. Alternatively, the weight drive unit 130 may be configured as a vibration-type motor configured to generate vibration of a vibration body provided on one of a weight and a rail and move the weight by bringing the vibration body into contact with the other of the weight and the rail. Moreover, a drive unit with a well-known configuration, such as a DC motor configured to move a weight by rotating a tire attached to the weight and contacting a rail, may be used.

The attitude measurement unit 140 measures (detects) the attitude of the body 300 by using an acceleration sensor, a gyro sensor, the GPS, or the like. In a case where the drone 30 has an imaging function, the attitude may be measured by using an imaged video.

The attitude converter 150 estimates the attitude of the body 300, which changes in accordance with the control amount. In other words, the attitude converter 150 estimates the attitude of the body 300 as a result of rotation control of the propellers 310 in accordance with the control amount. Specifically, the attitude converter 150 converts the control amount into attitude by using an attitude conversion value. The attitude conversion value for each control amount may be held as table data. The attitude may be estimated by a method using a moving average or the like. As an example of the attitude estimation, since the rotation speed of each propeller 310 is substantially equal while the body 300 is hovering, an attitude with which the body 300 is horizontal in the front, back, right, and left directions is estimated. In addition, since the rotation speeds of propellers 310 positioned on the front side of the body 300 in the moving direction are lower than the rotation speeds of propellers 310 positioned on the back side in the moving direction while the body 300 is moving in the horizontal direction, an attitude with which the front side of the body 300 in the moving direction is lower than the back side in the moving direction is estimated. In this manner, different attitudes are estimated in accordance with the magnitude relation among the rotation speeds of the propellers 310.

The compensator 160 outputs, to the weight drive unit 130, a compensation value corresponding to a deviation that is the difference between the attitude (hereinafter referred to as actual attitude) detected by the attitude measurement unit 140 and the attitude (hereinafter referred to as estimated attitude) obtained by the attitude converter 150. Specifically, the compensation value is output so as to reduce the deviation between the actual attitude and the estimated attitude, in other words, to restore the changed attitude of the body 300. Accordingly, as the deviation (that is, the change amount of the attitude) is larger, a larger compensation value is output and the movement amount of the weight 330 increases. Alternatively, the movement amount of the weight 330 may be increased as the change speed of the attitude of the body 300 increases.

The compensator 160 also outputs, to the weight drive unit 130, a compensation value for moving the weight 330 by a movement amount that a movement amount component corresponding to attitude change of the body 300 due to a reaction force (reaction) received by the body 300 from the moving weight 330 is subtracted. Accordingly, influence of the reaction force when the weight 330 moves on the attitude of the body 300 can be reduced.

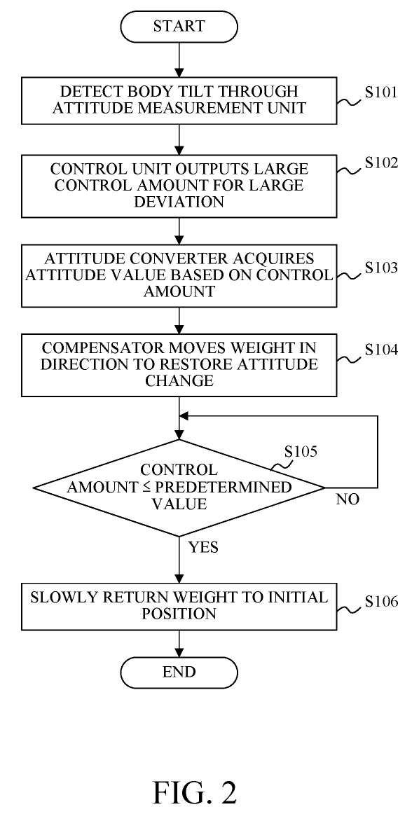

A flowchart of FIG. 2 illustrates weight control processing (control method) that an attitude control apparatus constituted by a CPU as a control unit including the control unit 110, the attitude converter 150, and the compensator 160 executes in accordance with a computer program stored in a ROM or the like in the present example.

The weight control processing is processing that assists attitude restoration through rotation control of the propellers 310 by moving the weight 330 (at least one of the weights 330a and 330b) relative to the body 300 when abrupt attitude change due to disturbances such as windblast has occurred to the flying drone 30. In the drone 30, the attitude of the body 300 is controlled about three axes of pitch, roll, and yaw as illustrated in FIG. 3A in reality, but in the following, only attitude control about one axis will be described for simplification. Attitude control processing of the present example is also applicable to attitude control about four axes or more. These are the same for other examples to be described later.

When attitude change (tilt) due to disturbances occurs to the drone 30 flying in accordance with an instruction from the instruction unit 390, the CPU detects a tilt as the actual attitude of the body 300 through the attitude measurement unit 140 at step S101. Accordingly, large deviation is input to the control unit 110.

Subsequently at step S102, the control unit 110 outputs a large control amount corresponding to the large deviation to the propeller drive unit 120 and the attitude converter 150. The propeller drive unit 120 rotates the propellers 310 in accordance with the input control amount.

Subsequently at step S103, the attitude converter 150 acquires an estimated attitude (attitude value) based on the control amount from the control unit 110 and sends the the estimated attitude to the compensator 160.

Subsequently at step S104, the compensator 160 outputs, as a compensation amount to the weight drive unit 130, the difference between the estimated attitude from the attitude converter 150 and the actual attitude detected by the attitude measurement unit 140, in other words, an amount yet to be restored for the stable attitude of the body 300 before the occurrence of disturbances under rotation control of the propellers 310. In accordance with the input compensation amount, the weight drive unit 130 moves the weight 330 from the initial position in a direction to restore the attitude change of the body 300.

Then at step S105, the CPU determines whether the control amount from the control unit 110 has become equal to or smaller than a predetermined value and the attitude of the body 300 is stabilized. In a case where the attitude is stabilized, the CPU causes the weight drive unit 130 to slowly return the weight 330 to the initial position at step S106, and then ends the present processing.

According to the present example, by moving the weight 330 when abrupt attitude change has occurred to the body 300, it is possible to immediately restore and stabilize the attitude as compared to a case where the attitude is restored only through rotation control of the propellers 310.

### Example 2

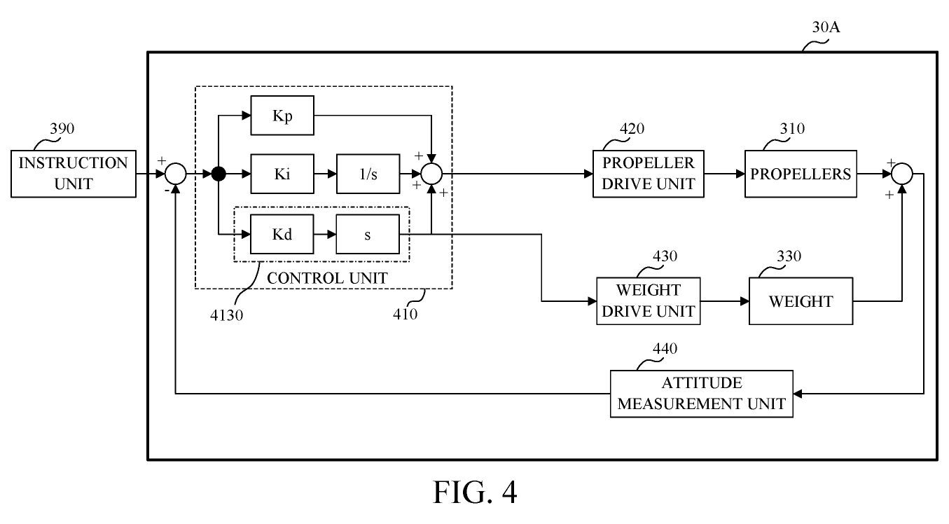

Example 2 will be described below. The appearance of a drone 30A as a flying object of Example 2 is the same as that of the drone 30 of Example 1. The drone 30A of the present example has an electric configuration illustrated in FIG. 4. The drone 30A includes, inside the body 300, a control unit 410, a propeller drive unit 420, a weight drive unit 430, and an attitude measurement unit 440. The control unit 410 includes a differentiator 4130. In the present example, movement of the weight 330 upon attitude change of the body 300 is controlled by the differentiator 4130 in the control unit 410. Specifically, movement of the weight 330 is controlled based on the differential gain of the differentiator 4130.

The control unit 410 is a PID control unit configured to calculate a control amount necessary for controlling flight of the drone 30A in accordance with an instruction input from the instruction unit 390. The differentiator 4130 is part of the PID control unit that calculates the control amount.

The propeller drive unit 420 rotationally drives the propellers 310 at a rotation speed in accordance with the control amount input from the control unit 410.

The weight drive unit 430 moves the weight 330 based on a differential amount input from the differentiator 4130 of the control unit 410.

The attitude measurement unit 440 measures (detects) the attitude of the body 300 by using an acceleration sensor, a gyro sensor, the GPS, or the like.

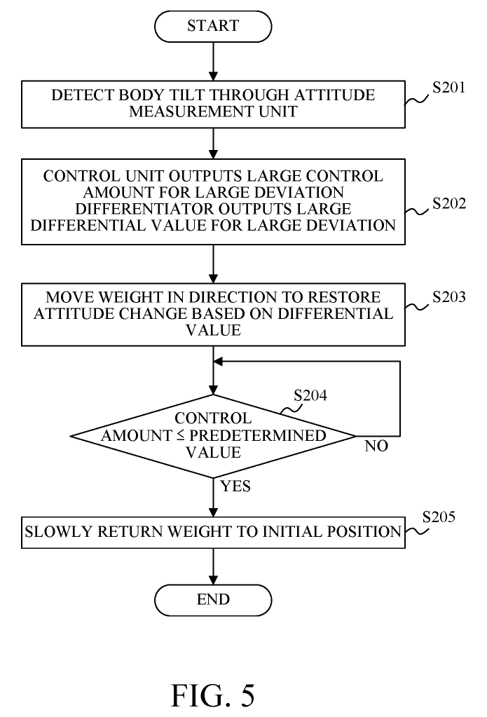

A flowchart of FIG. 5 illustrates weight control processing executed by an attitude control apparatus constituted by a CPU including the control unit 410 in the present example.

When attitude change (tilt) due to disturbances occurs to the drone 30A flying in accordance with an instruction from the instruction unit 390, the CPU detects a tilt as the actual attitude of the body 300 through the attitude measurement unit 440 at step S201. Accordingly, large deviation is input to the control unit 410.

Subsequently at step S202, the control unit 410 outputs a large control amount corresponding to the large deviation to the propeller drive unit 420. The propeller drive unit 420 rotates the propellers 310 in accordance with the input control amount. In addition, the differentiator 4130 of the control unit 410 differentiates the large deviation and outputs a large differential value as its result to the weight drive unit 430.

Subsequently at step S203, in accordance with the large differential value from the differentiator 4130, the weight drive unit 430 moves the weight 330 from the initial position in a direction to restore the attitude change of the body 300.

Then at step S204, the CPU determines whether the control amount from the control unit 410 has become equal to or smaller than a predetermined value and the attitude of the body 300 is stabilized. In a case where the attitude is stabilized, the CPU causes the weight drive unit 130 to slowly return the weight 330 to the initial position at step S205, and then ends the present processing.

According to the present example as well, by moving the weight 330 when abrupt attitude change has occurred to the body 300, it is possible to immediately restore and stabilize the attitude as compared to a case where the attitude is restored only through rotation control of the propellers 310.

### Example 3

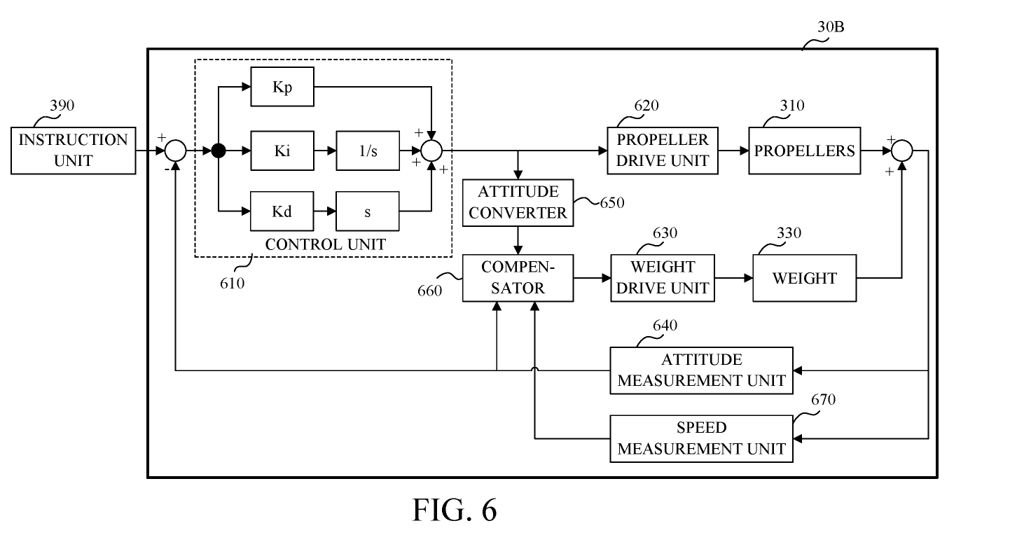

Example 3 will be described below. The appearance of a drone 30B as a flying object of Example 3 is the same as that of the drone 30 of Example 1. The drone 30B of the present example has an electric configuration illustrated in FIG. 6. The drone 30B includes, inside the body 300, a control unit 610, a propeller drive unit 620, a weight drive unit 630, an attitude measurement unit 640, a compensator 660, an attitude converter 650, and a speed measurement unit 670. In the present example, the movement amount of the weight 330 upon attitude change of the body 300 is controlled in accordance with the flight speed. Specifically, the amount of attitude change of the body 300 due to disturbances is likely to be larger as the flight speed is faster, and thus the movement amount of the weight 330 is set to be larger when the flight speed is fast than when the flight speed is slow.

The control unit 610 is a PID control unit configured to calculate a control amount necessary for controlling flight of the drone 30B in accordance with an instruction input from the instruction unit 390.

The propeller drive unit 620 rotationally drives the propellers 310 at a rotation speed corresponding to the control amount input from the control unit 610.

The weight drive unit 630 moves the weight 330 based on a compensation amount input from the compensator 660.

The attitude measurement unit 640 measures (detects) the attitude of the body 300 by using an acceleration sensor, a gyro sensor, the GPS, or the like.

Similarly to the attitude converter 150 of Example 1, the attitude converter 650 estimates the attitude of the body 300, which changes in accordance with the control amount.

The speed measurement unit 670 measures (detects) the flight speed of the drone 30 by using an acceleration sensor, a gyro sensor, the GPS, or the like and outputs the result of the detection to the compensator 660. The speed measurement unit 670 may be integrated with the attitude measurement unit 640.

The compensator 660 generates a compensation value corresponding to the deviation between the actual attitude detected by the attitude measurement unit 640 and the estimated attitude obtained by the attitude converter 650, and also generates a corrected compensation value by multiplying the compensation value by a correction value (hereinafter referred to as speed correction value) corresponding to the flight speed detected by the speed measurement unit 670. The compensator 660 outputs the corrected compensation value to the weight drive unit 630. The speed correction value is, for example, a value of one to two: one when the flight speed is slow; a value (for example, 1.2, 1.5, or 1.8) larger than one as the flight speed is faster; and two at maximum flight speed. Since the compensation value is multiplied by the speed correction value, a larger corrected compensation value is input to the weight drive unit 630 as the flight speed is faster, and as a result, the movement amount of the weight 330 is larger as the flight speed is faster..

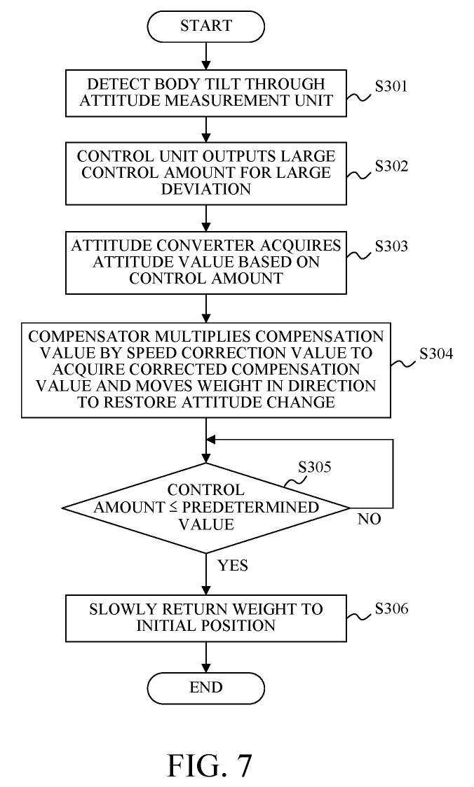

A flowchart of FIG. 7 illustrates attitude control processing executed by an attitude control apparatus constituted by a CPU including the control unit 610, the attitude converter 650, and the compensator 160 in the present example.

When attitude change (tilt) due to disturbances occurs to the drone 30 flying in accordance with an instruction from the instruction unit 390, the CPU detects a tilt as the actual attitude of the body 300 through the attitude measurement unit 640 at step S301. Accordingly, large deviation is input to the control unit 610.

Subsequently at step S302, the control unit 610 outputs a large control amount corresponding to the large deviation to the propeller drive unit 620 and the attitude converter 650. The propeller drive unit 620 rotates the propellers 310 in accordance with the input control amount.

Subsequently at step S303, the attitude converter 650 acquires an estimated attitude (attitude value) based on the control amount from the control unit 610 and sends the estimated attitude to the compensator 660.

Subsequently at step S304, the compensator 660 generates, as a compensation amount, the difference between the estimated attitude from the attitude converter 650 and the actual attitude detected by the attitude measurement unit 640. In addition, the compensator 660 generates a corrected compensation value by multiplying the compensation amount by a correction value (speed correction value) corresponding to the flight speed acquired from the speed measurement unit 670, and outputs the corrected compensation value to the weight drive unit 130. In accordance with the input corrected compensation value, the weight drive unit 130 moves the weight 330 from the initial position in a direction to restore the attitude change of the body 300.

Then at step S305, the CPU determines whether the control amount from the control unit 610 has become equal to or smaller than a predetermined value and the attitude of the body 300 is stabilized. In a case where the attitude is stabilized, the CPU causes the weight drive unit 630 to slowly return the weight 330 to the initial position at step S306, and then ends the present processing.

According to the present example as well, by moving the weight 330 when abrupt attitude change has occurred to the body 300, it is possible to immediately restore and stabilize the attitude as compared to a case where the attitude is restored only through rotation control of the propellers 310. Moreover, it is possible to immediately restore the attitude irrespective of the flight speed.

Although the control amount is calculated by the PID control scheme in the above-described examples, the control amount may be calculated by any other control scheme as long as the control amount for restoring the changed attitude of the body can be calculated by the control scheme.

Although the movement amount of each weight is controlled to increase as the change amount or change speed of the attitude of the body increases in the above-described examples, the movement amount of each weight may be constant irrespective of the change amount nor change speed of the attitude.

Although a flying object generates thrust by rotation of propellers in the above-described examples, thrust may be generated by means other than propellers, such as jet engines.

Although the attitude of the body 300 is controlled by moving the weight 330 in the above-described examples, a movable unit used for application other than attitude control may be used as the weight. For example, a movable unit including an imaging unit (including an image sensor and a lens) capable of capturing images of the circumference of the body 300 may be used as a movable weight as in the above-described examples. With this configuration, an imaged video is disrupted when abrupt change of the attitude of the body 300 has occurred during imaging with the imaging unit, and thus the attitude of the body 300 may be controlled by moving the movable unit irrespective of whether whether imaging is in progress. Moreover, attitude control of the body 300 by moving the movable unit may not be performed during imaging but may be performed during non-imaging.

### Other Embodiments

Embodiment(s) of the disclosure can also be realized by a computer of a system or apparatus that reads out and executes computer-executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

Each example can immediately restore and stabilize the attitude of a flying object when abrupt attitude change due to disturbances has occurred to the flying object.

While the disclosure has described example embodiments, it is to be understood that the disclosure is not limited to the example embodiments. The scope of the following claims is to be accorded the broadest interpretation so as to encompass all such modifications and equivalent structures and functions.

What is claimed is:

1. An attitude control apparatus included in a flying object configured to generate thrust in accordance with a control amount, the attitude control apparatus comprising:
a movable unit that is movable relative to a body of the flying object;
a drive unit configured to move the movable unit; and
a processor configured to output the control amount for restoring an attitude of the body when the attitude has changed and to control the drive unit to move the movable unit in a direction to restore the attitude.

2. The attitude control apparatus according to claim 1, wherein the processor is configured to control the drive unit so that a movement amount of the movable unit increases as a change amount or change speed of the attitude of the body increases.

3. The attitude control apparatus according to claim 1, wherein the processor is configured to calculate the control amount by PID control.

4. The attitude control apparatus according to claim 1, wherein the processor is configured to acquire an estimated attitude of the body from the control amount, detect an actual attitude of the body, and control the drive unit to move the movable unit in a direction to decrease difference between the estimated attitude and the actual attitude.

5. The attitude control apparatus according to claim 3, wherein the processor is configured to control the drive unit in accordance with a differential gain in the PID control.

6. The attitude control apparatus according to claim 1, wherein the processor is configured to acquire a flight speed of the flying object and control the drive unit to move the movable unit by a movement amount in accordance with the flight speed.

7. The attitude control apparatus according to claim 1, wherein the flying object generates the thrust by rotation of a plurality of propellers provided at mutually different positions on the body, and the processor is configured to control the rotation of the propellers in accordance with the control amount.

8. The attitude control apparatus according to claim 1, wherein the processor is configured to control the drive unit to move the movable unit by a movement amount that a movement amount component corresponding to attitude change of the body due to a reaction force received by the body from the moving movable unit is subtracted.

9. The attitude control apparatus according to claim 1, wherein the movable unit moves on a gravity direction side further than a center of gravity of the body.

10. The attitude control apparatus according to claim 1, wherein the movable unit moves along a rail provided on the body, and the rail has a curved shape that is convex from the body in a gravity direction.

11. A flying object comprising:
an attitude control apparatus configured to generate thrust in accordance with a control amount; and
a body,
wherein the attitude control apparatus includes:
a movable unit capable of moving relative to a body of the flying object;
a drive unit configured to move the movable unit; and
a processor configured to output the control amount for restoring an attitude of the body when the attitude has changed and control the drive unit to move the movable unit in a direction to restore the attitude.

12. The flying object according to claim 11, wherein the movable unit includes an imaging unit.

13. An attitude control method comprising:
controlling an attitude of a flying object configured to generate thrust in accordance with a control amount; and
moving a movable unit relative to a body of the flying object,
wherein when an attitude of the body has changed, the control amount for restoring the attitude is output and the movable unit is moved in a direction to restore the attitude.

14. A non-transitory computer-readable storage medium storing a computer program that causes a computer to execute the attitude control method according to claim 13.
